(19) United States
(12) Patent Application Publication
(10) Pub. No.: US 2023/0195587 A1
(43) Pub. Date: Jun. 22, 2023

(54) SYSTEM FOR DETERMINING A CARBON FOOTPRINT OF A COMPUTING INFRASTRUCTURE IN REAL TIME

(71) Applicant: BULL SAS, Les Clayes-sous-Bois (FR)

(72) Inventors: Pierre SEROUL, SINARD (FR); Lionel BOUZON, CRETS-EN-BELLEDONNE (FR); Titouan JOUFFRAY, GRENOBLE (FR)

(73) Assignee: BULL SAS, Les Clayes-sous-Bois (FR)

(21) Appl. No.: 18/081,602

(22) Filed: Dec. 14, 2022

(30) Foreign Application Priority Data
Dec. 20, 2021 (EP) 21306852.1

(51) Int. Cl. G06F 11/30

(52) U.S. Cl. CPC G06F 11/3058; G06F 11/3082; G06F 2219/10

(57) ABSTRACT

A device for determining a carbon footprint of a computing infrastructure in real time, including a collector that collect equipment data that includes, for each computing equipment, a measurement of its energy consumption and its time-stamped location, a receiver that received, for each site, a carbon intensity value provided by an electricity supplier of the each site, and a consolidator that associated a carbon intensity value of the each site with each computing equipment according to the time-stamped location of the computing equipment. The consolidator calculates the carbon footprint of each computing equipment from the carbon intensity value that is associated and the energy consumption that is measured.

This application claims priority to European Patent Application Number 21306852.1, filed 20 Dec. 2021, the specification of which is hereby incorporated herein by reference.

### BACKGROUND OF THE INVENTION

### Field of the Invention

The invention relates to the field of carbon footprints of computing infrastructures and more particularly relates to a device for determining the carbon footprint of a computing infrastructure in real time and a system comprising a computing infrastructure and such a device.

### Description of the Related Art

In France, the energy transition law for green growth requires companies to comprise the carbon footprint of their business in their annual management report. The establishment of this footprint is based on estimation methods, not measurement methods. Within the context of computing systems, this estimate is too general because it does not enable the solutions implemented to reduce the carbon impact of a computing infrastructure to be taken into account.

For example, changing the supply parameters of a fleet of laptops, optimizing network flows in a supercomputer, using frugal artificial intelligence algorithms are all levers that are not taken into account when establishing a company's carbon footprint. For digital services companies (ESN), these differences are significant.

There are many solutions on the market for monitoring a computing system (for example Telegraf®, MetricBeat® or Collectd®). These transfer agents retrieve metrics from information systems regardless of the operating system (Linux®, Windows®, Mac OS®, Android®, IOS®) and send them to centralized databases. However, the information collected on the electrical power consumed depends on the system settings. For example, Telegraf® enables power consumption to be retrieved under Linux® via the Powerstat® tool, but there is no equivalence for Windows®. Furthermore, the systems indicated do not work on Android® or IOS®.

Other systems such as PowerAPI® combined or not with SmartWatts® are dedicated to the energy consumption of the computing systems. On the other hand, they are only interested in measuring the central processing unit (CPU) and random access memory (RAM) via the use of the “RAPL” (Running Average Power Limit) registers, but do not take into account the consumption of graphical processing units (GPUs) and tensor processing units (TPUs), which are significant in a number of applications such as artificial intelligence.

Finally, not all of these tools measure a carbon footprint that depends not only on the amount of electricity consumed but also on its carbon intensity, which varies over time and location.

There are a few specific tools to measure the carbon footprint of a particular IT solution. The best known is CodeCarbon®. In particular, the latter enables the energy consumption of the CPU to be monitored via the use of RAPLs and that of the GPU via a library called “NVIDIA Management Library”. Via a location system, the tool is able to determine in which country or on which cloud solution the computing system is hosted. Finally, the tool retrieves the carbon intensity of the country in order to determine the carbon footprint of the computing equipment studied.

Although this solution is more comprehensive than conventional monitoring agents, it has a few limitations. First of all, it is not an application or service as such, it has to be embedded in the code of the application whose fingerprint is being assessed. It is therefore not adapted for continuous operation on computing infrastructures. Then, it is not supported by Android® and IOS® systems. In addition, location data used to calculate the carbon footprint is only accurate at a country or region level.

There is therefore a need for a simple and effective solution to overcome at least some of these drawbacks.

### BRIEF SUMMARY OF THE INVENTION

One or more embodiments of the invention enable the carbon intensities to be taken into account at a site to which computing equipment is attached, in particular a site manufacturing all or part of its electricity. At least one embodiment of the invention enables the calculation of the energy footprint of nomadic computing systems (laptops, smartphones, etc.). One or more embodiments of the invention measures in real time the carbon footprint of a computing infrastructure rather than to estimate it as provided by previous approaches, in order to be able to quantify the effect of an energy saving solution at the level of a computing infrastructure. At least one embodiment of the invention measures in real time the carbon footprint of a distributed computing infrastructure. One or more embodiments of the invention measures the carbon footprint of a heterogeneous computing infrastructure.

To this end, at least one embodiment of the invention is firstly a device for determining the carbon footprint of a computing infrastructure in real time, said computing infrastructure comprising a set of pieces of computing equipment on at least one site, said device comprising:
a first database,
a second database,
a collection module configured to collect so-called “equipment” data from the set of pieces of computing equipment and record it in the first database, said equipment data comprising, for each computing equipment, the measurement of its energy consumption and its time-stamped location,
a receive module configured to receive, for each site, a carbon intensity value provided by the electricity supplier of the site, and to record it in the first database,
a consolidation module configured to associate a carbon intensity value of a site, recorded in the first database, with each computing equipment according to the time-stamped location of said computing equipment, to calculate the carbon footprint of each computing equipment from the associated carbon intensity value and its measured energy consumption recorded in the first database and to record the carbon footprint calculated in the second database.

By the term “computing infrastructure”, it is meant a set of pieces of computing equipment distributed over one or more sites and each connected to the device by a communication link (wired or wireless) via one or more communication networks.

By the term “carbon intensity provided by the electricity supplier of the site”, it is meant the carbon intensity of the local electricity grid's country of the electricity supplier of the site. The carbon intensity is an indicator that correlates the amount of greenhouse gasses emitted by an entity, measured by its carbon dioxide equivalent, to the electricity consumption of that entity (here in the country or region of the electricity grid).

One or more embodiments of the invention therefore provides a computing solution for measuring the carbon footprint in real time related to the use of a computing infrastructure. In particular, at least one embodiment of the invention comprises the time-stamped measurement of energy expenditure (kWh) of a heterogeneous computer population (telephones, computers, servers, routers, supercomputers, etc.), the location of each computing equipment in real time, the reporting of consumption time-stamped power supply and location data (kWh) centrally and securely, the retrieval of carbon intensities (for example in gCO2/kWh) of the electricity grids for the countries on which the infrastructure is deployed, the calculation of carbon intensities of the sites on which the infrastructure is deployed in the event that this site produces part of its electricity (for example by solar panels, diesel generators, wind turbines, geothermal energy, fuel cells, etc.), the identification, for each emission source, of the carbon intensity to be taken into account according to its location and time-stamping, the calculation of the carbon footprint (gCO2) of the complete computing structure and these sub-assemblies. The carbon footprint is calculated in real time. In other words, the provided solution of one or more embodiments of the invention takes into account the electricity consumed and the variability of the carbon intensity in real time. This variation is taken into account whether it is the carbon intensity of the country's electricity grid or that of a site (if the site uses several power supply sources). These variations are not negligible, for example, between day and night. In France, an application running at night will have a carbon footprint 1.5 to 2 times lower than during the day.

Advantageously, by way of at least one embodiment, the equipment data further comprises the power supply mode of the computing equipment. The power supply mode indication for systems with a battery can be used to determine at a given time instant whether the computing equipment is powered by its battery or by mains power. Thus, the carbon footprint will be calculated with equipment data dated from the last time the computing equipment was powered from the mains in order to make the carbon footprint measurement relevant and therefore reliable. In particular, in at least one embodiment, this enables the device according to one or more embodiments of the invention to calculate the energy footprint of nomadic computer systems (laptops, smartphones, etc.) when charging said systems even if the energy is used retrospectively, which improves the accuracy of the carbon footprint.

In at least one embodiment, at least one site comprising an electricity production module and consuming electricity produced by said electricity production module, said electricity production module comprising one or more local electricity production sources installed on said at least one site and being configured to generate so-called “production and location” data comprising the measurement of the electrical energy production of one or more local electricity production sources, for example for a given amount of time, and its location, the device comprises a calculation module configured to:
receive the carbon intensity value provided by the electricity supplier for said site,
calculate in real time the carbon intensity consumed by the set of pieces of computing equipment of said site from the production and location data received from the electricity production module and the carbon intensity value provided per receive module,
record the carbon intensity calculated in the first database.

Preferably, in one or more embodiments, the carbon intensity Cisite consumed at a given time instant on a site from the mixture between the carbon intensity of the grid and those of the locally produced electrical energy sources is given, in energy (and not in power), by the following equation:

$${CI}_{site} = \frac{1}{{P}_{conso}} ( {\sum }_{source} {CI}_{source} \times {P}_{source} + ( {P}_{conso} - {\sum }_{source} {P}_{source} ) \times {CI}_{grid} ) \qquad [ Math 1 ]$$

where Pconso is the overall consumption of the site at the time instant t, CIsource is the carbon intensity of a source, Psource is the power of said source and CIgrid is the carbon intensity of the electricity grid.

According to one or more embodiments of the invention, the device comprises an aggregation module configured to aggregate the data relating to the carbon footprints from the second database for the computing infrastructure to determine its overall carbon footprint.

Advantageously, in at least one embodiment, the aggregation module is configured to aggregate carbon footprint data from the second database per site and/or per type of computing equipment.

Advantageously, in one or more embodiments, the aggregation module is configured to aggregate the data relating to the carbon footprints from the second database for a subpart of the computing infrastructure such as, for example, a business unit, department, team, etc.

According to at least one embodiment of the invention, the device comprises a visualization module comprising a display screen, said visualization module being configured to receive the aggregated data provided by the aggregation module and to display the aggregated data received.

At least one embodiment of the invention also relates to computing equipment for measuring the carbon footprint of a computing infrastructure installed on at least one site in real time, said computing equipment being configured to determine its energy consumption in real time and its time-stamped location and to send the energy consumption determined and the time-stamped location determined to a device as set forth previously.

Advantageously, by way of one or more embodiments, in particular for portable or mobile computing equipment (smartphone, laptop, etc.), the computing equipment is configured to identify its power supply mode at a given time instant and to send the type of said mode identified to the device.

At least one embodiment of the invention also relates to a computing infrastructure comprising a plurality of pieces of computing equipment as set forth above distributed over several sites.

Preferably, in one or more embodiments, the computing infrastructure is heterogeneous, that is, there are several types of computing equipment. Thus the carbon footprint is calculated for a heterogeneous computing infrastructure. In other words, the carbon footprint concerns various pieces of computing equipment (telephones, computers, servers, routers, supercomputers, etc.) working on different operating systems (Windows®, Linux®, Mac OS®, Android®, IOS®, for example).

Preferably, in at least one embodiment, the computing infrastructure is distributed, that is, the computing equipment is located in several geographically distinct sites. Thus, the carbon footprint is calculated on a distributed computing infrastructure. In other words, the carbon footprint concerns computing equipment distributed on several sites, that are themselves distributed in several countries. This requires that the location of each computing equipment is taken into account in order to assign it the carbon intensity of its electricity supplier (the country or site in the event that the site generates all or part of its electricity).

One or more embodiments of the invention also relates to a system for determining the carbon footprint of a computing infrastructure in real time, said system comprising:
a computing infrastructure comprising a set of pieces of computing equipment on at least one site,
a device as set forth above.

In at least one embodiment, at least one site comprises an electricity production module comprising one or more local electricity production sources installed on said at least one site, said electricity production module being configured to:
produce, and preferably store, electricity,
generate so-called “production and location” data comprising the measurement of the electrical energy production of one or more local electricity production sources, and the location of the site,
send the production data to the device.

One or more embodiments of the invention also relates to a method for determining the carbon footprint of a computing infrastructure in real time, said computing infrastructure comprising a set of pieces of computing equipment on at least one site, said method, implemented by a device as set forth previously, comprising the steps of:
collecting so-called “equipment” data from the set of pieces of computing equipment, said equipment data comprising, for each computing equipment, the measurement of its energy consumption and its time-stamped location,
recording the data collected in the first database,
receiving, for each site, a carbon intensity value provided by the electricity supplier of the site,
recording the value received in the first database,
associating a carbon intensity value of a site, recorded in the first database, with each computing equipment according to the time-stamped location of said computing equipment,
calculating the carbon footprint of each computing equipment from the carbon intensity value associated and its measured energy consumption recorded in the first database,
recording the carbon footprint calculated in the second database.

At least one embodiment of the invention also relates to a computer program product wherein it comprises a set of program code instructions which, when executed by one or more processors, configure the processor(s) to implement a method as set forth above implemented by the device.

At least one embodiment of the invention also relates to a method implemented by computing equipment as set forth previously, said method comprising the steps of:
determining the energy consumption in real time and the time-stamped location of said computing equipment,
sending the energy consumption determined and the time-stamped location determined to a device as set forth previously.

Advantageously, by way of one or more embodiments, in particular for portable or mobile computing equipment (smartphone, laptop, etc.), the method further comprises a step of identifying the power supply mode of the computing equipment and a step of sending said identified mode to the device.

At least one embodiment of the invention also relates to a computer program product wherein it comprises a set of program code instructions which, when executed by one or more processors, configure the processor(s) to implement a method as set forth above implemented by the computing equipment.

At least one embodiment of the invention also relates to a method implemented by a system as set forth previously, said method comprising the steps of:
determining the energy consumption in real-time and the time-stamped location by each computing equipment of the computing infrastructure,
sending by each computing equipment the energy consumption determined and the time-stamped location determined to the device,
collecting so-called “equipment” data from the set of pieces of computing equipment, said equipment data comprising, for each computing equipment, the measurement of its energy consumption and its time-stamped location,
recording the data collected in the first database,
sending by the electricity supplier of each site a carbon intensity value,
receiving, for each site, a carbon intensity value provided by the electricity supplier of the site,
recording the value received in the first database,
associating a carbon intensity value of a site, recorded in the first database, with each computing equipment according to the time-stamped location of said computing equipment,
calculating the carbon footprint of each computing equipment from the carbon intensity value associated and its measured energy consumption recorded in the first database,
recording the carbon footprint calculated in the second database.

### BRIEF DESCRIPTION OF THE DRAWINGS

Other features and advantages of one or more embodiments of the invention will further appear upon reading the description that follows. This is for illustrative purposes only and should be read in conjunction with the appended drawings in which:

FIG. 1 schematically illustrates the system according to one or more embodiments of the invention.

FIG. 2 schematically illustrates the device according to one or more embodiments of the invention.

FIG. 3 schematically illustrates the method according to one or more embodiments of the invention.

### DETAILED DESCRIPTION OF THE INVENTION

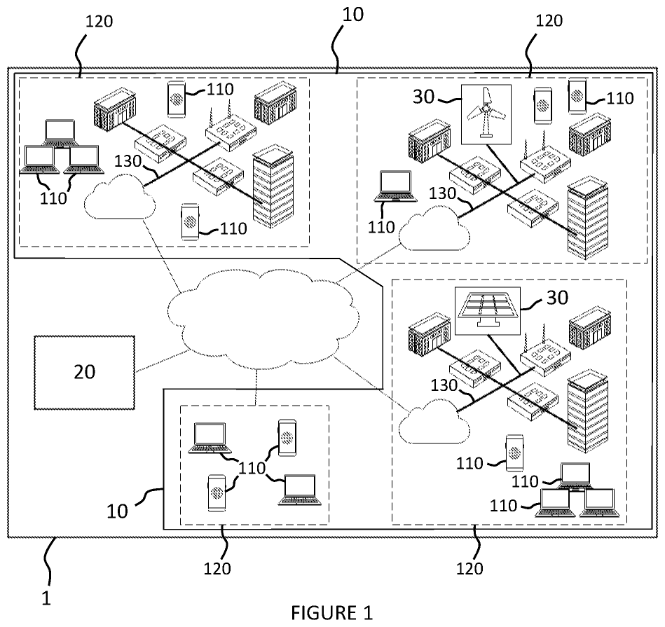

An example of system 1 according to one or more embodiments of the invention is represented in FIG. 1.

System 1

The system 1 comprises a computing infrastructure 10 and a device 20.

Computing Infrastructure 10

The computing infrastructure 10 comprises a set of pieces of computing equipment 110 distributed over one or more sites 120.

In the example in FIG. 1, by way of at least one embodiment, the computing infrastructure is heterogeneous, that is, the pieces of computing equipment 110 are of several types, and distributed, that is, the pieces of computing equipment 110 are distributed over several sites 120.

Computing Equipment 110

By the term “computing equipment” 110, it is meant both portable, fixed or mobile user equipment, such as a smartphone or laptop, and fixed equipment such as a fixed computer, supercomputer, server, router, etc.

The computing equipment 110 is configured to determine its energy consumption in real time and its time-stamped location.

To this end, in at least one embodiment, the computing equipment 110 preferably comprises a micro-service configured to collect energy consumption data from said computing equipment 110, that is, to measure the electrical energy consumption of said computing equipment 110. Preferably, in one or more embodiments, the micro-service is developed according to several versions around a common base to adapt to the operating system (Linux®, Windows®, Mac OS®, Android®, IOS®) of the computing equipment 110 but also to the hardware architecture (RAPL register, NVidia®, Baseboard Management Controller (BMC)) of the computing equipment 110. Energy consumption measurement is made both when charging computing equipment 110, in order to identify the energy source to be taken into account, and when using it, to identify the impact of each use parameter. The energy consumption measurement is made periodically, for example with a default period of 1 second.

The micro-service makes it possible to geographically locate the computing equipment 110 according to several modes: preferably by GPS® or via the use of other technologies (Bluetooth®, Wi-Fi®, cellular modem, etc.). This location is time-stamped, the measurement is preferably made at each start-up, then periodically, for example, every hour. It identifies which carbon intensity to use: that of the electricity grid of the country where the computing equipment 110 is located or of a site 120 generating all or part of its electricity.

The computing equipment 110 is configured to send the energy consumption determined and the time-stamped location determined to the device 20.

Advantageously, by way of at least one embodiment, in particular for portable or mobile computing equipment 110 (smartphone, laptop, etc.), the computing equipment 110 is configured to identify its power supply mode and to send said mode identified to the device 20. In particular, in at least one embodiment, micro-service enables the power supply mode of computing equipment with a battery (laptop, smartphone) to be identified. In the case of mains use, the carbon intensity of the electricity grid in real time will be used. In the case of battery use, the carbon intensity at the time of charging this battery will be used in the calculation of the carbon footprint.

In order to transfer equipment data to the device 20, the computing equipment 110 preferably comprises a data transfer micro-service. This micro-service enables configuring the sending of consumption, location and power supply mode data for each computing equipment 110 to the device 20. Communication is preferably made via encryption and authentication of each computing equipment 110. In the event that the system is connected to the internet, this data is transmitted, for example, once an hour, this periodicity being configurable. In the opposite case, they are stored locally while waiting for a next connection.

Site 120

By the term “site” 120, it is meant both a mobile (or nomadic) zone grouping one or more pieces of mobile computing equipment 110 and a fixed zone grouping one or more pieces of mobile and/or fixed computing equipment 110. For example, a site could be a building or a group of buildings, or a roaming smartphone.

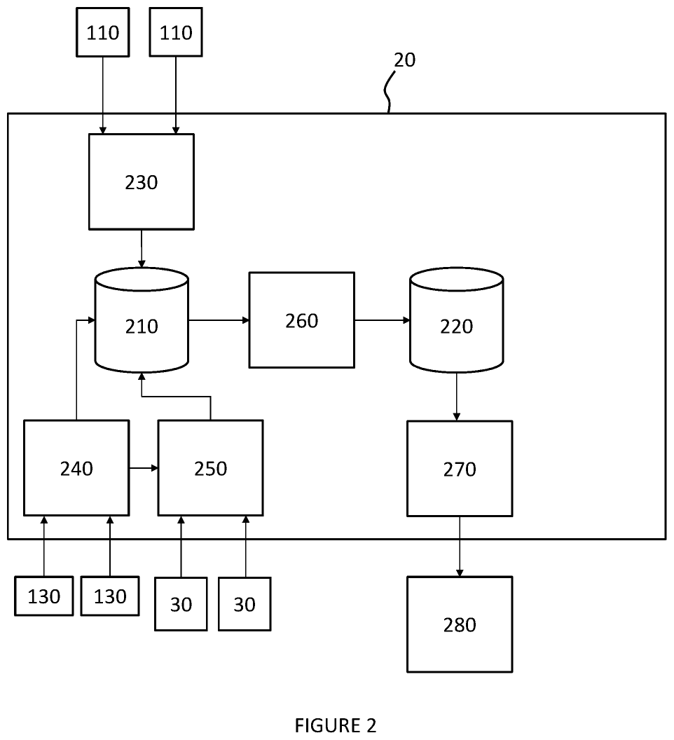

One or more of the sites 120 can produce their own electricity and consume a mixture of electricity produced on site 120, in particular stored in electricity storage units, and electricity received from an electricity grid of an electricity supplier 130 (FIG. 2). In this case, the site(s) 120 producing electricity each advantageously comprise, still with reference to FIG. 2, an electricity production module 30.

The electricity production module 30 is configured to produce electricity at least for the site 120 on which it is installed. This production may be of solar or wind origin or generated by one or more generators, for example a heat engine, or provided by electrical storage units, particularly of the battery or fuel cell type. In particular, in at least one embodiment, the energy produced can be stored in electrical storage units of the electricity production module 30 for subsequent return.

The electricity production module 30 is configured to generate production and location data comprising the measurement of the electricity production by the source(s) of said electricity production module 30 and the location of the site 102.

The electricity production module 30 is configured to send the production and location data to the device 20.

Device 20

An example of device 20 is represented in FIG. 2, according to one or more embodiments of the invention.

The device 20 enables the real-time determination of the carbon footprint of the computing infrastructure 10.

The device 20 comprises a first database 210, a second database 220, a collection module 230, a receive module 240 and a consolidation module 260.

In the example in FIG. 2, by way of at least one embodiment, the device 20 further comprises a calculation module 250 and an aggregation module 270 and the system further comprises a visualization module 280 external to the device 20.

First Database 210

The first database 210 comprises equipment data received from the collection module 230 and the carbon intensity of each site 120 provided either by the receive module 240 or by the calculation module 250.

The equipment data comprises, for each computing equipment 110, the measurement of its energy consumption and its time-stamped location. In addition, the equipment data may advantageously comprise the power supply mode of the computing equipment 110.

Second Database 220

The second database 220 comprises consolidated data provided by the consolidation module 260.

Collection Module 230

The collection module 230 is configured to collect so-called “equipment” data from the set of pieces of computing equipment 110 and record it in the first database 210.

Preferably, in at least one embodiment, the collection module 230 uses a micro-service. Advantageously, in one or more embodiments, the micro-service uses an MQTT (Message Queuing Telemetry Transport) type data transfer protocol to communicate with the computing equipment 110, for example an MQTT broker such as Mosquitto®.

Receive Module 240

The receive module 240 is configured to receive, for each site 120, a carbon intensity value provided by the electricity supplier 130 of said site 120, and to record it in the first database 210.

By the terms “carbon intensity provided by the electricity supplier 130 of said site 120”, it is meant the carbon intensity of the local electricity grid's country of the electricity supplier 130 of the site 120. The carbon intensity, given for example in gCO2eq/kWh, is an indicator that correlates the amount of greenhouse gasses emitted by an entity, measured by its carbon dioxide equivalent, to the electrical energy consumed by that entity, given for example in kWh.

Energy and electrical stakeholders provide real-time carbon intensity information from different countries around the world through the use of APIs (Application Programming Interface). This is particularly the case for the RTE®, Opendata.energie.fr®, Electricitymap®, CO2source®, ENTSOE®, etc. sites.

To receive the carbon intensity values, the receive module 240 preferably comprises a micro-service connecting periodically, for example once an hour, to the different sites of the electricity suppliers 130 in order to retrieve carbon intensity values of the electricity grids of the different countries.

Calculation Module 250

Certain sites of a company can use electricity that comes from both the country's electricity grid and their own production. This production may, for example, be of solar, wind origin, via diesel generators or storage units (battery, fuel cell, etc.).

The calculation module 250 is used for the sites 120 that produce electricity via an electricity production module 30 and consume both said electricity produced and electricity from a local electricity grid to which site 120 is connected.

The calculation module 250 is used to calculate in real time the carbon intensity consumed by the computing equipment 110 located on each site 120 producing electricity. This carbon intensity varies over time depending on the energy intensity of the electricity grid and the electricity mix produced on the site 120.

The calculation module 250 is configured to receive the carbon intensity value provided by the receive module 240 for each site 120 producing electricity and to calculate in real time the carbon intensity consumed by the set of pieces of computing equipment 110 of each site 120 producing electricity from the production and location data received from the electricity production module 30 of said site 120 and the carbon intensity value provided per receive module 240.

The carbon intensity Cisite consumed at a given time instant on a site 120 from the mix between the carbon intensity of the electricity grid 130 of the electricity supplier and those of the local energy sources of the electricity production module 30 is given by the following equation (in energy and not in power):

$${CI}_{site} = \frac{1}{{P}_{conso}} ( {\sum }_{source} {CI}_{source} \times {P}_{source} + ( {P}_{conso} - {\sum }_{source} {P}_{source} ) \times {CI}_{grid} ) \qquad [ Math 1 ]$$

In other words, by way of one or more embodiments, the carbon intensity Cisite of the site 120 is the cross-product between the carbon intensity of the local power sources brought back to their production capacity at the given time instant, and the carbon intensity of the electricity grid for the part of power still to be provided. Storage units (batteries, fuel cells, etc.) may be considered as both consumers or sources depending on their power supply mode. As consumers, they will consume with a carbon intensity Cisite. As a producer, they will produce with the carbon intensity Cisite at the different time instants of charging thereof. Likewise, for nomadic systems, this value should be used either at the given time instant when they are connected to the mains (that is, connected to the electricity grid), or at a time instant (t-A) corresponding to the last charging period.

The calculation module 250 is configured to store the carbon intensity calculated for each site 120 in the first database 210.

The calculation module 250 preferably comprises a micro-service implementing these different functions.

Consolidation Module 260

The consolidation module 260 aims to assign the right carbon intensity to each computing equipment 110 according to its location and time.

To this end, in at least one embodiment, the consolidation module 260 is configured to associate (or assign) the carbon intensity value of a site 120 recorded in the first database 210 with each computing equipment 110 according to the time-stamped location of said computing equipment 110.

The consolidation module 260 is configured to calculate the carbon footprint of each computing equipment 110 from the carbon intensity value associated and its energy consumption measured, recorded in the first database 210.

The time-stamped carbon intensity of each site 120 is obtained from the receive module 240 for the sites 120 which do not produce electricity or is calculated by the calculation module 250 for the sites 120 which produce electricity.

Each computing equipment 110 is assigned to a site 120 according to this location and time data (time-stamped location).

If the computing equipment 110 is located too far from a site 120, it is attached to the country in which it is located. A nomadic computing equipment 110 (telephone, laptop, etc.) may therefore be attached successively to several sites according to the time-stamping.

For each time step (for example by default per second), the carbon footprint of the computing equipment 110 is calculated by multiplying the consumption data (kWh) by the carbon intensity data (gCO2/kWh) of the site 120 to which it is attached at time instant T.

For the computing equipment 110 in battery mode, it is the carbon intensity of the site 120 at the time of recharging that will be used.

For this purpose in particular, by way of one or more embodiments, the carbon intensity values of all sites 120 and electricity suppliers 130 may be stored periodically in the first database 210 for a predetermined period of time, for example a few years.

The consolidation module 260 is configured to store the carbon footprint calculated in the second database 220.

The consolidation module 260 preferably comprises a micro-service implementing these different functions.

Aggregation Module 270

The aggregation module 270 is configured to aggregate the data relating to the carbon footprints recorded in the second database 220 for the computing infrastructure 10 in order to determine its overall carbon footprint.

So as to obtain a more or less overall view of the carbon footprint of a computing infrastructure 10, the data relating to each computing equipment 110 may be aggregated according to several criteria.

Advantageously, in one or more embodiments, the aggregation module 270 is configured to aggregate the data relating to the carbon footprints recorded in the second database 220 per site 120 and/or type (that is, family) of computing equipment 110 (smartphones, laptops, supercomputers, servers, etc.).

Advantageously, in at least one embodiment, the aggregation module 270 is configured to aggregate the data relating to the carbon footprints recorded in the second database 220 for one or more sub-parts of the computing infrastructure 10 such as, for example, a business unit, department, team, etc.

The aggregation module 270 preferably comprises a micro-service implementing these different functions.

Visualization Module 280

The visualization module 280 comprises a display screen (not represented) and is configured to receive the aggregated data provided by the aggregation module 270 and to display the aggregated data received on said display screen. The visualization module 280 may, for example, be based on a visualization tool such as Grafana® or Kibana®.

The device 20 comprises one or more processors capable of implementing a set of instructions enabling the functions of its various modules to be carried out.

### Example of Implementation of the Invention

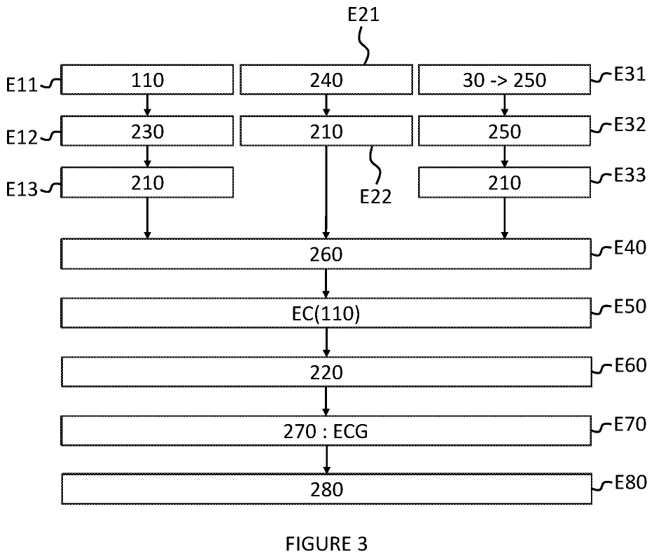

An example of implementation will now be described with reference to FIG. 3, according to one or more embodiments of the invention.

In a step E11, the computing equipment 110 determines, preferably periodically, for example every second, its energy consumption and time-stamped location and sends this equipment data to the collection module 230.

The power consumption may be given in mW, W, kW, etc. For example, a laptop may have a power consumption of 20-40 W, that is, 20-40 Wh if running for one hour. A high-power compute node (HPC node) may have a power consumption of 100 W to 900 W. For example, a smartphone may have a power consumption of 10 to 500 mW.

The location may be given by coordinates, for example of GPS type or any other adapted parameter.

The equipment data is collected by the collection module 230 in a step E12 and recorded in the first database 210 in a step E13.

In parallel with steps E11 to E13, the receive module 240 receives from each electricity grid, preferably periodically, for example every hour, the carbon intensity values of each site 120 in a step E21 and records in the first database 210 said carbon intensity values received in a step E22.

In parallel to the steps E11-E13 and E21-E22, the calculation module 250 receives in a step E31 the production and location data of the electricity production modules 30 of the sites 120 producing electricity and, for each site 120 producing electricity, the carbon intensity value provided by the receive module 240 (or obtained from the first database 210) then calculates in real time in a step E32 the carbon intensity consumed by the set of pieces of computing equipment 110 of each site 120 producing electricity from the production and location data received from the electricity production module 30 of said site 120 and the carbon intensity value provided per receive module 240 and records in a step E33 the carbon intensity value of each site 120 in the first database E210.

Then, the consolidation module 260 associates, in a step E40, the carbon intensity value of a site 120 recorded in the first database 210 (received from the electricity supplier 130 associated with the site 120 or calculated by the calculation module 250) with each computing equipment 110 according to the time-stamped location of said computing equipment 110.

The consolidation module 260 then calculates in a step E50 the carbon footprint EC of each computing equipment 110 from the carbon intensity value associated and its measured energy consumption recorded in the first database 210.

The consolidation module 260 then records the carbon footprints EC calculated in the second database 220 in a step E60.

The aggregation module 270 then aggregates in a step E70 the data relating to the carbon footprints EC recorded in the second database 220 for the computing infrastructure 10 to determine its overall carbon footprint ECG.

Alternatively or in addition, in at least one embodiment, the aggregation module 270 may aggregate the data relating to the carbon footprints recorded in the second database 220 per site 120 and/or per type of computing equipment 110.

Still alternatively or in addition, in one or more embodiments, the aggregation module 270 may aggregate the data relating to the carbon footprints recorded in the second database 220 for one or more sub-parts of the computing infrastructure 10 such as, for example, a business unit, department, team, etc.

Finally, in a step E80, the visualization module 280 receives the aggregated data provided by the aggregation module 270 and displays the aggregated data received on the display screen of the visualization module 280.

At least one embodiment of the invention therefore enables a reliable and efficient real-time measurement of the carbon footprint of a computing infrastructure 10.

1. A system for determining a carbon footprint of a computing infrastructure in real time, said computing infrastructure comprising a set of pieces of computing equipment on at least one site, said system comprising:
a device that comprises
a first database,
a second database,
a collector configured to collect equipment data from the set of pieces of computing equipment and record the equipment data in the first database, wherein said equipment data comprises, for each computing equipment of the set of pieces of computing equipment, a measurement of an energy consumption of said each computing equipment and a time-stamped location of said each computing equipment,
a receiver configured to receive, for each site of said at least one site, a carbon intensity value provided by an electricity supplier of the each site, and to record said carbon intensity value in said first database,
a consolidator configured to
associate said carbon intensity value of said each site of said at least one site, recorded in the first database, with said each computing equipment according to the time-stamped location of said each computing equipment,
calculate the carbon footprint of said each computing equipment from the carbon intensity value that is associated and said energy consumption of said each computing equipment that is measured and recorded in the first database, and
record the carbon footprint that is calculated in the second database.

2. The system according to claim 1, wherein the equipment data further comprises a power supply mode of the computing equipment.

3. The system according to claim 1, wherein said at least one site comprises
an electricity production source and consumes electricity produced by said electricity production source, and
one or more local electricity production sources installed on said at least one site,
wherein said electricity production source is configured to generate production and location data comprising
a measurement of electrical energy production of said one or more local electricity production sources, and
a location of the at least one site,
wherein the device further comprises a calculator configured to
receive the carbon intensity value provided by the electricity supplier for said each site,
calculate, in real time, the carbon intensity consumed by the set of pieces of computing equipment of said each site from the production and location data received from the electricity production source and the carbon intensity value provided per said receiver,
record the carbon intensity value calculated in the first database.

4. The system according to claim 1, further comprising an aggregator configured to aggregate data relating to the carbon footprint of said each computing equipment of the second database for the computing infrastructure to determine an overall carbon footprint.

5. The system according to claim 4, wherein the aggregator is further configured to aggregate the data relating to the carbon footprint of said each computing equipment of the second database per one or more of said each site and type of computing equipment.

6. The system according to claim 4, wherein the aggregator is further configured to aggregate the data relating to the carbon footprint of said each computing equipment of the second database for a subpart of the computing infrastructure.

7. The system according to claim 4, further comprising a a display screen, said display screen being configured to receive the data that is aggregated provided by the aggregator and to display the data that is aggregated and received.

8. The system according to claim 1, further comprising a computing equipment of said set of pieces of computing equipment that measures the carbon footprint of said computing infrastructure installed on said at least one site in real time, wherein said computing equipment is configured to determine the energy consumption in real time and the time-stamped location and to send the energy consumption that is measured and the time-stamped location that is measured to said device.

9. The system according to claim 8, wherein said computing equipment is configured to identify a power supply mode of said computing equipment at a given time instant and to send a type of said power supply mode that is identified to the device.

10. (canceled)

11. The system according to claim 1, wherein the computing infrastructure is heterogeneous.

12. The system according to claim 1, wherein the computing infrastructure is distributed.

13. The system according to claim 1, wherein the at least one site comprises an electricity production source comprising one or more local electricity production sources installed on the at least one site, wherein said electricity production source is configured to generate and store electricity,
generate production and location data comprising
a measurement of electrical energy production of said one or more local electricity production sources, and
a location of the at least one site,
send the production and location data to said device.

14. A method for determining a carbon footprint of a computing infrastructure in real time, said computing infrastructure comprising a set of pieces of computing equipment on at least one site, wherein said method is implemented by a device that comprises
a first database,
a second database,
a collector,
a receiver, and
a consolidator,
wherein said method comprises:
collecting equipment data, via said collector, from the set of pieces of computing equipment, said equipment data comprising, for each computing equipment of the set of pieces of computing equipment, a measurement of energy consumption of said each computing equipment and a time-stamped location of said each computing equipment,
recording the equipment data that is collected in the first database via said collector,
receiving, via said receiver, for each site of said at least one site, a carbon intensity value provided by an electricity supplier of the each site,
recording, via said receiver, the carbon intensity value received in the first database,
associating, via said consolidator, said carbon intensity value of said each site of said at least one site, recorded in the first database, with said each computing equipment according to the time-stamped location of said each computing equipment,
calculating, via the consolidator, the carbon footprint of said each computing equipment from the carbon intensity value that is associated and said energy consumption of said each computing equipment that is recorded in the first database,
recording the carbon footprint that is calculated in the second database.

15. A computer program product that comprises a set of program code instructions which, when executed by one or more processors, configure the one or more processors to implement a method for determining a carbon footprint of a computing infrastructure in real time, said computing infrastructure comprising a set of pieces of computing equipment on at least one site,
wherein said method is implemented by a device that comprises
a first database,
a second database,
a collector,
a receiver, and
a consolidator,
wherein said method comprises:
collecting equipment data, via said collector, from the set of pieces of computing equipment, said equipment data comprising, for each computing equipment of the set of pieces of computing equipment, a measurement of energy consumption of said each computing equipment and a time-stamped location of said each computing equipment,
recording the equipment data that is collected in the first database via said collector,
receiving, via said receiver, for each site of said at least one site, a carbon intensity value provided by an electricity supplier of the each site,
recording, via said receiver, the carbon intensity value received in the first database,
associating, via said consolidator, said carbon intensity value of said each site of said at least one site, recorded in the first database, with said each computing equipment according to the time-stamped location of said each computing equipment,
calculating, via the consolidator, the carbon footprint of said each computing equipment from the carbon intensity value that is associated and said energy consumption of said each computing equipment that is recorded in the first database,
recording the carbon footprint that is calculated in the second database.
